(19) United States
(12) Patent Application Publication
(10) Pub. No.: US 2007/0162734 A1
(43) Pub. Date: Jul. 12, 2007

(54) Initializing circuit, initializing apparatus and initializing method for intializing an apparatus

(75) Inventor: Tadanori Noguchi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/649,209

(22) Filed: Jan. 4, 2007

(30) Foreign Application Priority Data
Jan. 10, 2006 (JP) 2006-002611

(51) Int. Cl. G06F 9/00

(52) U.S. Cl. 713/1

(57) ABSTRACT

An initializing circuit for initializing an initializing apparatus, the initializing circuit includes information making a work area operable in order to make a common boot program operate there as hardware placed separately from the common boot program.

### BACKGROUND OF THE INVENTION

1. Field of the Invention

The present invention relates to an initializing circuit, an initializing apparatus and an initializing method for initializing an apparatus, and more particularly to an initializing circuit, an initializing apparatus and an initializing method that can be used in a control apparatus for IP system and the like.

2. Description of Related Art

In general, a computer or control apparatus mounting a CPU (Central Processing Unit) has an initial program (hereinafter referred to as a BOOT program) for initializing a main program. A control apparatus for IP system (hereinafter referred to as a IP system control apparatus) such as a Gateway or Media Converter for use in an IP-PBX (Internet Protocol—private branch exchange) also has a BOOT program.

As the processing system devices becoming a core of the IP system control apparatus for IP-PBX, there are a CPU and its peripheral devices (ROM: Read Only Memory, RAM: Random Access Memory, etc.). These are not different for each apparatus, except for a difference in the capacity, and the almost same devices are used.

However, in the IP system control apparatus for IP-PBX, an individual hardware device may exist separately from the above processing system device. Therefore, it is necessary to generate a dedicated BOOT program individually. However, to generate the dedicated BOOT program, a series of development phases, including design, manufacture and evaluation, occurs. Therefore, a great number of man-hours are required.

Herein, a microcomputer intended to reduce the load of program development by the user was offered in a related document 1 (Japanese Patent Application Laid-Open No. 2003-308307, Patent family US2003/0159027A1), for example. A CPU of this microcomputer, if released from the reset state, accesses a boot ROM before executing the user program stored in a user ROM. And then, this CPU performs an initial setting process required for executing the user program by executing an initial setting program stored in the boot ROM. In this offer, a program for performing the initial setting process is stored in the boot ROM. Therefore, it is unnecessary to make descriptions on the initial setting process in the user program stored in the user ROM, whereby the load of program generation is relieved.

However, the above offer has the following problems. An initial setting program stored in the boot ROM for initializing the apparatus must be generated exclusively in accordance with the configuration of each apparatus. Therefore, a great number of man-hours are required for generating the dedicated initial setting program individually.

### SUMMARY OF THE INVENTION

In view of the foregoing and other exemplary problems, drawbacks, and disadvantages of the related art methods and structures, exemplary feature of the present invention is to provide an initializing circuit, an initializing apparatus and an initializing method for initializing an apparatus with a simple configuration and method in which a load of program development for each control apparatus is relieved.

An initializing circuit according to the present invention for initializing an initializing apparatus, the initializing circuit includes information making a work area operable in order to make a common boot program operate there as hardware placed separately from the common boot program.

An initializing apparatus according to the present invention for initializing a control apparatus, the initializing apparatus includes (1) a CPU (Central Processing unit) for executing various kinds of program, (2) a read only memory having a common boot program, (3) a random access memory for making the common boot program operate, (4) an initializing circuit having information for making the random access memory operable on the hardware, and (5) a host bus connecting them.

An initializing method according to the present invention for initializing a control apparatus, the initializing method includes making a work area operable in order to make a common boot program operate based on information incorporated into hardware provided separately from the common boot program.

The initializing circuit, the initializing apparatus and the initializing method for initializing an apparatus according to the present invention have the advantage that the apparatus can be initialized with the simple configuration and method in which the load of program development for each control apparatus is relieved with the above configuration and method.

### BRIEF DESCRIPTION OF THE DRAWINGS

The exemplary aspects, features and advantages of the present invention will become more apparent from the following detailed description when taken in conjunction with the accompanying drawings wherein:

FIG. 1 is a hardware block diagram of a IP system control apparatus according to an embodiment of the present invention;

FIG. 2 is a diagram showing a first processing operation of the IP system control apparatus according to the embodiment of the present invention;

FIG. 3 is a diagram showing a second processing operation of the IP system control apparatus according to the embodiment of the present invention;

FIG. 4 is a diagram showing a third processing operation of the IP system control apparatus according to the embodiment of the present invention;

FIG. 5 is a diagram showing a fourth processing operation of the IP system control apparatus according to the embodiment of the present invention; and

FIG. 6 is a diagram showing a fifth processing operation of the IP system control apparatus according to the embodiment of the present invention.

### DETAILED DESCRIPTION OF THE EXEMPLARY ASPECTS

Exemplary aspects for carrying out the present invention will be described in detail below with reference to the drawing. The exemplary aspects described below show only illustrative examples in understanding the present invention, and the claims of the invention are not limited to these exemplary aspects.

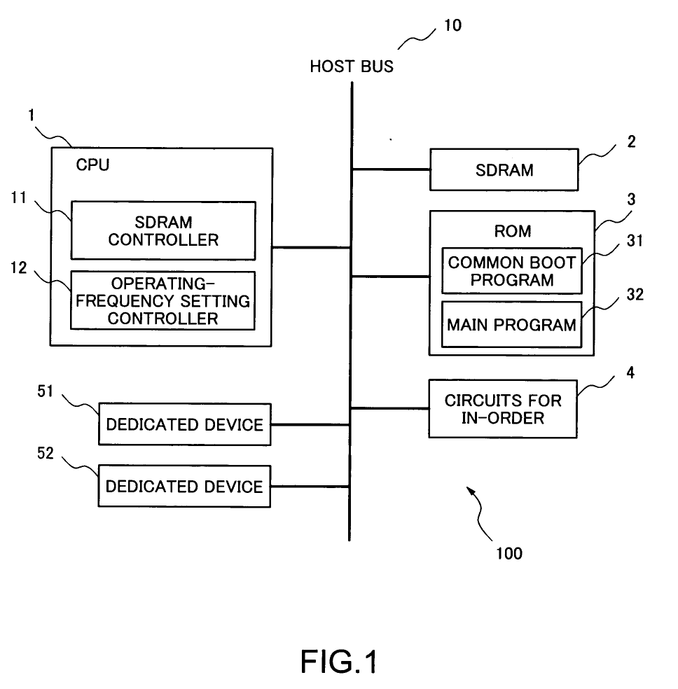

An initializing circuit, an initializing apparatus and an initializing method for initializing an apparatus according to an embodiment of the present invention will be described below in detail. FIG. 1 is a hardware block diagram of a IP system control apparatus according to the embodiment of the present invention. The following explanation is based on FIG. 1. The “initializing circuit” as defined in the claims is specified as “circuits for in-order” in the following description of the embodiment. The circuits for in-order are typically called “Scan Order”.

The IP system control apparatus 100 for IP-PBX according to this embodiment includes a CPU 1, an SDRAM 2, a ROM 3, and circuits for in-order 4. The IP system control apparatus 100 may further include the dedicated devices 51 and 52. The number of dedicated devices may be adequately increased or decreased, as needed. These are connected via a host bus 10.

The CPU 1 includes an SDRAM controller 11 and an operating-frequency setting controller 12. The SDRAM controller 11 is designed to acquire various set values of a register from the circuits for in-order 4. For example, the set values of the capacity of SDRAM, bus width to the SDRAM and the input clock frequency among the set values for use with control are acquired therefrom. And the other set values of the register are preset so that the SDRAM controller 11 will be operable at the initial set values of the register. The SDRAM controller may be mounted as an outer circuit of the CPU 1. The operating-frequency setting controller 12 allows an internal operating-frequency and an outer host bus frequency to be set up, based on information of input clock frequency to the CPU 1. That is, the controller can calculate various operation frequencies by arithmetic calculations based on information of input clock frequency.

The ROM 3 is a storage part having a common BOOT program 31. It does not matter what kind of ROM is employed.

The circuits for in-order 4 are constituted of hardware, and have two pieces of information, including RAM size information and an input clock frequency value. Also, the circuits for in-order 4 use a fixed address on a memory map. The RAM size information includes the bus width and the capacity, and the input clock frequency value includes the input clock frequency value to the CPU. The in-order is formed of a few bytes, and has a value in which various kinds of hardware information are encoded. Herein, the in-order means a reading processing. The circuits for in-order 4 can be realized with a simple circuit configuration.

Herein, the IP system control apparatus 100 is set up as follows. The setting of access wait to each device is basically made at the default value at the time of turning on the power. That is, each device is set up to be operable even if not set up by the common BOOT program 31. Also, the IP system control apparatus 100 is set up to disable outer interrupts to the CPU 1 even though any other device than the above is mounted around the CPU 1.

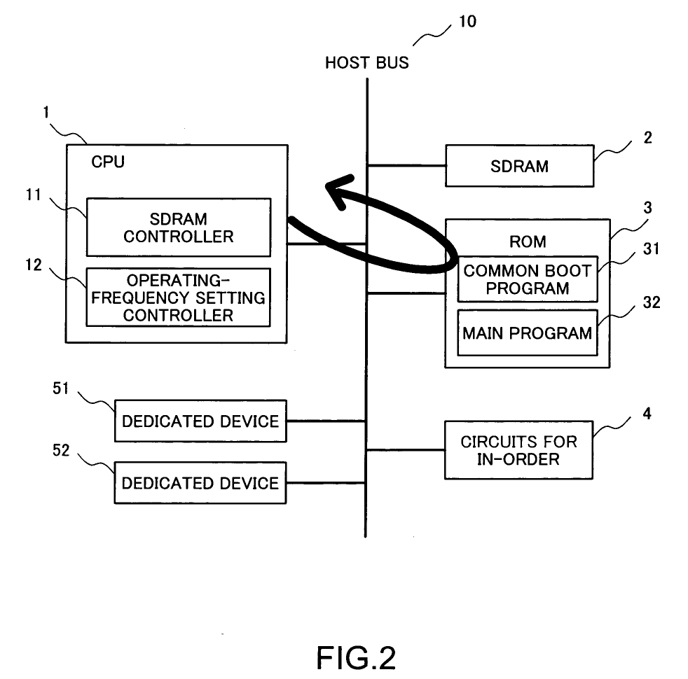

The operation of the initializing circuit and the initializing apparatus for initializing an apparatus according to the embodiment of the present invention will be described below. FIGS. 2 to 6 are diagrams showing the first to fifth processing operations of the IP system control apparatus according to the embodiment of the present invention. Referring to these drawings, a series of flows from initializing the common BOOT program to operation completion will be described in detail.

First of all, the CPU 1 accesses the ROM 3 after turning on the power, as shown in FIG. 2. And then, the CPU 1 starts to execute the common BOOT program 31. At this time, the CPU 1 allocates the common BOOT program 31 to the initial address of the ROM 3, and starts to execute it.

The setting for the CPU 1 to access the ROM 3 is specified beforehand by hardware. Therefore, it is unnecessary that the common BOOT program 31 performs this setting. Also, the other devices than the ROM 3 are idle. Furthermore, those devices are set up to disable interrupts to the CPU 1.

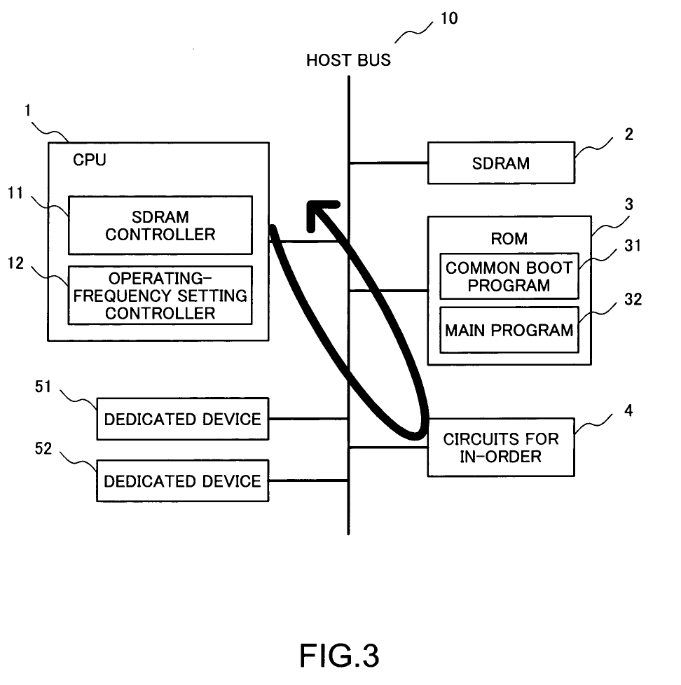

Next, the CPU1 acquires the values of RAM size information and input clock frequency from the circuits for in-order 4 that are outer circuits, as shown in FIG. 3. The CPU 1 sets up hardware of a work area (SDRAM 2) for making the common BOOT program 31 operate, based on those values. These values are acquired from the in-order that is decided beforehand by the circuits for in-order 4. In this manner, the CPU 1 acquires those information by outer access. A set value of the access wait of the CPU 1 is default. That is, the CPU 1 is operable without needing the setting by the common BOOT program 31.

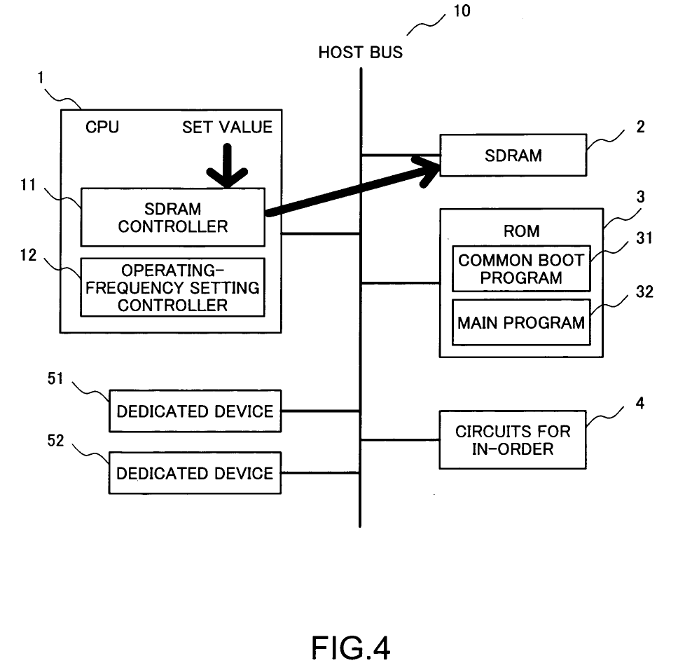

Next, the CPU 1 makes the register setting of an SDRAM controller 11 to access the SDRAM 2 with the information acquired from the in-order, as shown in FIG. 4. That is, the CPU 1 sets the optimal value of the register to the SDRAM controller 11 based on the information acquired from the in-order. Thereby, the SDRAM 2 is made operable.

The SDRAM 2 is a clock synchronous control device. Therefore, the SDRAM 2 requires the values of the capacity of SDRAM mounted and the input clock frequency. Thereby, the SDRAM 2 becomes accessible.

Also, various kinds of operating-frequency can be calculated from the values that the operating-frequency setting controller 12 has and the value of the input clock frequency.

The dedicated devices 51 and 52 in the IP system control apparatus 100 of FIG. 1 are largely classified into the following two; a device providing the functions specific to the apparatus and a device providing the universal functions in the IP system control apparatus. As the device providing the universal functions, there are control devices such as a serial device controller and an Ethernet controller. These devices may provide the universal functions during the operation of the BOOT program.

Thus, the CPU 1 initializes the serial device controller or makes the Ethernet controller operable with the dedicated devices 51 and 52, as needed. However, the initialization of the serial device controller is set to be operable at default by the CPU 1. The Ethernet controller mounts a device driver of the device that is recognized beforehand by the common BOOT program 31. The initialization of the Ethernet controller is also set to be operable at default by the CPU 1.

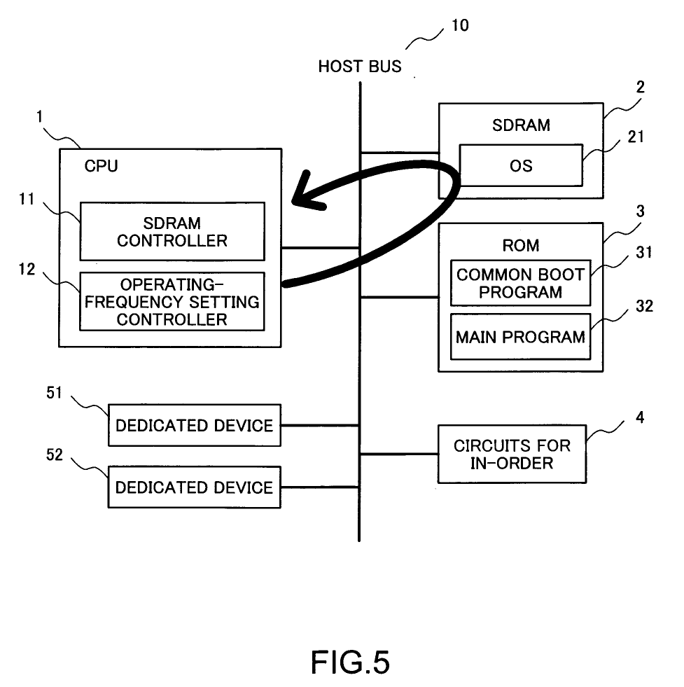

The SDRAM 2 includes an Operating System (hereinafter referred to as an OS) 21 as shown in FIG. 5. The OS 21 is a base (environment) for making the common BOOT program 31 operate. Thus, the operating-frequency is set to the OS 21. Since the SDRAM 2 is usable as the work memory, the OS 21 is constructed on the SDRAM 2.

In initializing the OS 21 that is the base (environment) for making the common BOOT program 31 operate, the operating-frequency of the CPU 1 (x multiple of input frequency) and the frequency of the dedicated devices 51 and 52 (y multiple of input frequency) may be required in some cases. In such cases, the OS 21 is made operable by specifying those values from the common BOOT program 31. The value of the input frequency can be acquired from the register values of the operating-frequency setting controller 12.

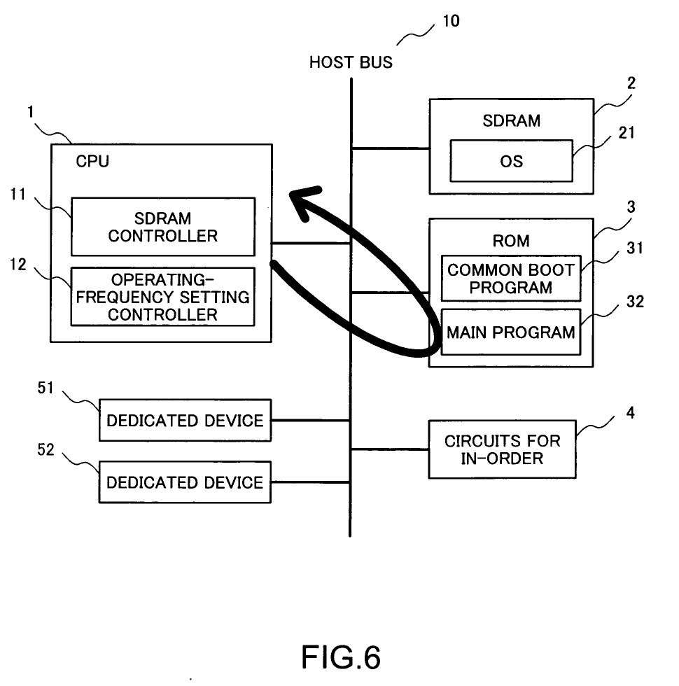

Finally, after the common BOOT program 31 is made operable on the SDRAM 2, the CPU 1 initializes and executes a main program 32 of a final object, as shown in FIG. 6. Thereby, the role of the common BOOT program 31 is ended.

The advantages of the initializing circuit, the initializing apparatus and the initializing method according to the embodiment of the present invention are as follows.

The initializing circuit, the initializing apparatus and the initializing method according to the embodiment of the present invention can initialize the control apparatus with the simple configuration and method in which the load of program development for each control apparatus is relieved with the above configuration and method.

It should be noted that the circuits for in-order can be realized with a simple circuit configuration, and provide inherent data for each apparatus to make the common BOOT program operate. Therefore, it is unnecessary to make the specific program development for each apparatus as conventionally performed. As a result, the initializing circuit, the initializing apparatus and the initializing method according to the embodiment of the present invention can reduce the number of development man-hours and relieve the load of development.

The above embodiment is a preferred embodiment of the present invention, but various modifications may be made thereto without departing from the spirit or scope of the present invention.

While in the above embodiment this technique is involved in one IP system control apparatus, it may be involved in a plurality of apparatuses.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. An initializing circuit for initializing an initializing apparatus, the initializing circuit comprising:
information making a work area operable in order to make a common boot program operate there as hardware placed separately from the common boot program.

2. The initializing circuit according to claim 1, wherein the information includes size information of the work area.

3. The initializing circuit according to claim 2, wherein the size information of the work area includes the information on a bus width to the work area and a capacity of the work area.

4. The initializing circuit according to claim 2, wherein the work area is configured with a random access memory.

5. The initializing circuit according to claim 1, wherein the information includes information of input clock frequency to a CPU for executing the common boot program.

6. An initializing apparatus for initializing a control apparatus, the initializing apparatus comprising:
a CPU (Central processing unit) for executing various kinds of program;
a read only memory having a common boot program;
a random access memory for making the common boot program operate;
an initializing circuit having information for making the random access memory operable on the hardware; and
a host bus connecting them.

7. The initializing apparatus according to claim 6, wherein the information includes size information of the random access memory.

8. The initializing apparatus according to claim 7, wherein the size information of the random access memory includes the information on a bus width to the random access memory and a capacity of the random access memory.

9. The initializing apparatus according to claim 6, wherein the information includes information of input clock frequency to the CPU.

10. The initializing apparatus according to claim 6, wherein the initializing apparatus inhibits interrupts of other programs to the CPU while the CPU is executing the common boot program.

11. An initializing method for initializing a control apparatus, the initializing method including:
making a work area operable in order to make a common boot program operate based on information incorporated into hardware provided separately from the common boot program.

12. The initializing method according to claim 11, wherein the information includes size information of the random access memory.

13. The initializing method according to claim 12, wherein the size information of the random access memory includes the information on a bus width to the random access memory and a capacity of the random access memory.

14. The initializing method according to claim 11, wherein the information includes information of input clock frequency to a CPU for executing the common boot program.

15. The initializing method according to claim 11, including executing the common boot program, reading the information incorporated into the hardware, and making the work area operable based on the information.

16. The initializing method according to claim 15, further including
inhibiting interrupts of other programs while executing the common boot program.
